(19) United States
(12) Patent Application Publication
(10) Pub. No.: US 2018/0368353 A1
(43) Pub. Date: Dec. 27, 2018

(54) LITTER BOX REMOVABLE DEVICES TO ASSIST IN NO MESS CLEANING AND RELATED ADHESIVE LITTER BOX BAG

(71) Applicant: Jennifer A. HUTCHINSON, Metuchen, NJ (US)

(72) Inventor: Jennifer A. HUTCHINSON, Metuchen, NJ (US)

(21) Appl. No.: 15/635,133

(22) Filed: Jun. 27, 2017

(51) Int. Cl. A01K 1/01

(52) U.S. Cl. CPC A01K 1/0107

(57) ABSTRACT

A removable litter box device to assist in no mess cleaning comprising a flat surface board; a pair of front legs attached to the board which include attachment means for attaching a waste bag; a pair of back legs attached to the board such that when the device is placed on a litter box pan the front legs are inside the pan and the back legs are outside the pan; and a waste bag, which fits over the attachment means and enables to user to clean the litter pan without litter spilling over outside the pan.

This application claims the benefit of U.S. provisional application Ser. No. 62/355,672 filed Jun. 28, 2016 and U.S. provisional application Ser. No. 62/442,277 filed Jan. 4, 2017 both of which are incorporated herein in their entirety by reference.

### FIELD OF THE INVENTION

The present invention relates to litter box removable devices to assist in cleaning the litter box with minimal mess. More specifically, it relates litter box removable devices placed on the inside wall of the litter box pan where a waste bag can be fixed to it to prevent a mess while cleaning. In an alternate embodiment the invention provides a litter box bag that has an adhesive strip on the outside of the bag that when the strip is peeled it adheres to the top inside edge of the litter box. The removable devices include a flap with hooks, device with hooks and clips with hooks, all with at least one hook placed on the inside wall of the litter box pan where a waste bag can be fixed to prevent a mess while cleaning,

### BACKGROUND OF THE INVENTION

Cleaning a litter box can be a messy process because litter can fall on the ground as it is moved from the litter box to the trash bag. There always seems to be a gap between the bag and the box where litter falls through the slits of a scooper onto the floor during a cleaning, which makes another mess that needs to be cleaned.

Furthermore, holding the trash bag above the litter box so litter doesn't fall onto the floor is not easy either, since holding the bag open with one hand and scooping out the litter with the other hand is difficult.

There isn't a simple method to make scooping out litter an easy, clean process.

The purpose of the invention is to provide a litter box or related device with hooks on the inside of the litter box that hold onto a waste bag and thereby alleviating the messy problems described above. Knobs or clips can also be use instead of hooks. In an alternate embodiment a plastic or rubber flap can be attached ed to the inner wall of the litter box which the waste bag hooks onto. This is a simple, quick, inexpensive way to eliminate a problem cat owner's deal with frequently.

The invention also provides a litter bag that has an adhesive strip on the outside edge of the bag. This adhesive strip is similar to that found on an envelope so it can be sealed. When an individual goes to clean the litter box, he/she peels off the paper strip that was covering the adhesive, and then attaches the adhesive strip to the top inside edge of the litter box. The bag then is temporarily stuck to the inside of the litter box thus eliminating the gap between the litter box and the waste lift bag so that one can scoop the waste litter out of the box without litter falling on the floor.

A variation of this idea is to have the adhesive strip on the inside flap, which could be stuck under the outside lip of the box, and later used to seal close the litter bag. The width and design of the adhesive strip can vary. Also, one side of the bag can be longer than the other to better secure the bag to the box, and/or the bag can have slits down the side or have stretchy sides (like the big Glad trash bags) to increase the ease of opening the bag wide enough to put litter in. The bag can also be scented to alleviate odors from the waste.

Alternatively, other related devices include a hinged flap with hooks, device with hooks and clips with hooks, all with at least one hook placed on the inside wall of the lifter box pan where a waste bag can be fixed too to prevent a mess while cleaning. The width of the hook can vary.

Another purpose of the invention is to provide a method to help prevent the spreading of litter that falls on the ground around houses.

Yet another purpose of the invention is to provide a method to help prevent hardwood floors from being damaged from litter that falls on the ground when someone cleans a litter box.

Another purpose of the invention is to provide a method to help prevent cat litter dust that falls on the floor during a litter box cleaning from being inhaled.

Yet another purpose of the invention is to help eliminate the odor that may linger from the cat litter that falls on the ground during a cleaning.

### SUMMARY OF THE INVENTION

In the present invention, these purposes, as well as others which will be apparent, are achieved generally by providing a removable litter box device to assist in no mess cleaning comprising a movable flat surface board; and a pair of attachment means for attaching a waste bag. The waste bag fits over the attachment means and enables to user to clean the litter pan without litter spilling over outside the pan. The flat surface can be secured to the inside litter box wall with magnets, clip into the wall, or be weighted at the bottom to prevent the flat surface from moving. A variation of this is to have no hooks, but instead have slits on the bottom of the flap which the bag can wrap around to be secured.

The attachment means are selected from the group consisting of hooks, magnets clips, knobs and flaps.

Preferably the attachment means are at least two hooks with a rounded curved pointed tip attached on opposite ends of said flat surface such that the curved pointed tip points in a downward position and the flat surface board is parallel to the litter box pan.

Another embodiment provides a removable litter box device made of at least one hook mounted on the front side of a flat surface; and two attachment means on the backside of the flat surface. The attachment means slide into place inside a litter box pan and a waste bag can be placed over said hooks.

In yet another embodiment a removable litter box device made of removable clips with hooks is provided.

In yet another embodiment, two movable squares, each with a hook, are incorporated into the side of a litter box. The hook side of the squares face outward from the litter box, and can then both squares can be pushed so that the hook moves to the inside of the litter box. The squares resemble the way the boxes on Wheel of Fortune used to move to reveal a letter. Once the hooks have been rotated to face the inside of the box, the litter bag can be attached for cleaning.

In all device embodiments the hooks have a curved pointed tip such that the tip is in a downward position so that a waste bag can be attached to said hooks.

The pan and hooks are preferably made of plastic.

Other objects, features and advantages of the present invention will be apparent when the detailed description of the preferred embodiments of the invention are considered with reference to the drawing, which should be construed in an illustrative and not limiting sense.

### BRIEF DESCRIPTION OF THE DRAWINGS

FIG. 1A illustrates a first embodiment of the invention where the removable device is two or more hooks which clip onto the rim of the litter box and FIG. 1B illustrates the bag attached to invention device on the wall of a litter box;

FIG. 2 illustrates a second embodiment of the invention which has a movable hinged flap with two hooks on the inside surface of the litter box;

FIG. 3 is the adhesive litter box bag according to the invention;

FIG. 4A illustrates a third embodiment where the device has two hooks on a clip which attaches to the backside of the litter box; FIG. 4B illustrates the third embodiment of the invention from multiple perspectives;

FIG. 5 shows two separate embodiments in one figure; a fourth embodiment which is a stationary flap on the wall of the litter box that protrudes from the side wall and can be used to attach a waste bag, a fifth embodiment is also shown on the opposite side where hook(s) are attached to the top wall of the inside of the litter box and is used to attach a waste bag; and

FIG. 6A and 6B illustrate a sixth embodiment of the invention which is a movable tab with hooks on one side to attach a waste bag. When not in use the movable tab can be flipped over with the hooks now on the backside of the litter box and the inside surface of the lifter box smooth.

### DETAILED DESCRIPTION OF THE INVENTION

The invention describes a number of litter box devices to assist in no mess cleaning. The components of the various embodiments are indicated as follows and shown in the accompanying figures:

1—lifter box side wall;

2—hook;

3—top bar on invention device;

4—overhang on backside of litter box side wall;

5—waste bag;

6—flap with hooks;

7—hinge;

8—waste bag with adhesive attachment;

9—adhesive attachment strip;

10—clip;

11—hooks and clip;

12—front plate on clip;

13—back plate on clip;

14—top clip holding front and back together on litter box side wall;

15—alternate mechanism to open and lock clip on litter box rim;

16—horizontal protrusion to secure clip in place on backside of litter box wall;

17—flap;

18—single curved and pointed hook;

19—movable tab front side with hooks; and

20—movable tab back side (no hooks).

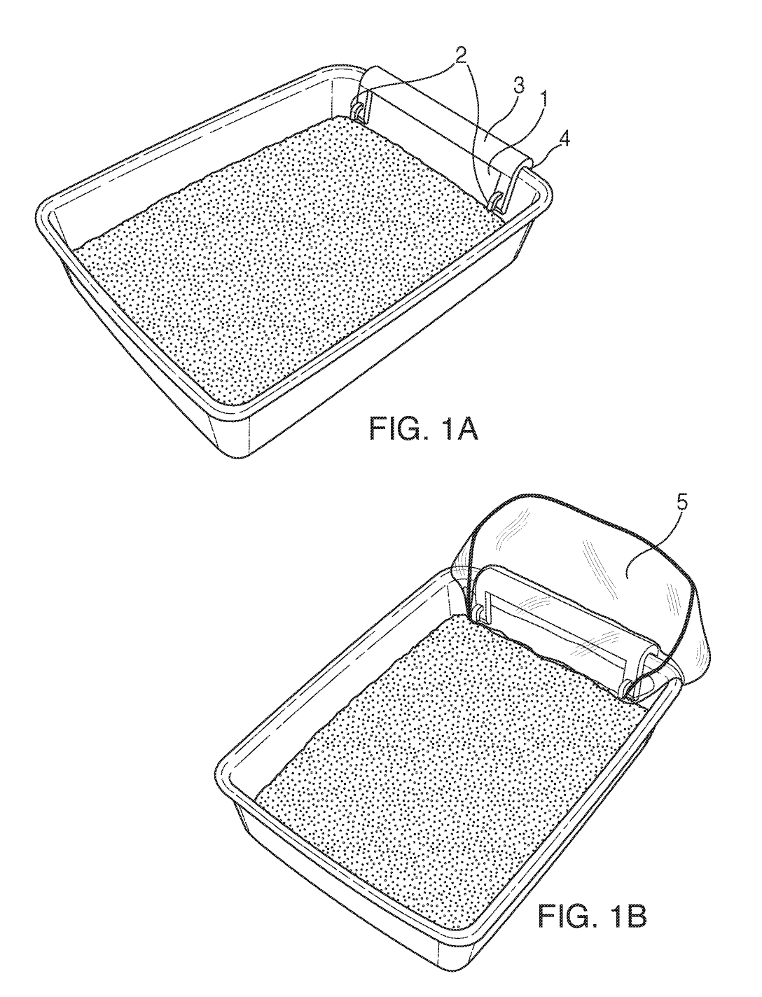

FIG. 1A illustrates a first embodiment of the invention where the removable device is two or more hooks 2 which clip onto the rim of the litter box 1. The device has a top bar 3 with an overhang on the backside of the litter box 4 to secure in place on the box. The hooks 2 are pointed in a downward direction so that the waste bag fits securely in place thereon. In alternate embodiments, one wide hook or two or more hooks can clip on to the rim or rest on it with four supports.

In an alternate embodiment the device is comprised of a flat surface board with at least two hooks with a curved pointed tip attached on opposite ends of the flat surface such that the curved pointed tip points in a downward position; a pair of front legs attached to the board; a pair of back legs attached to the board such that when said device is placed on a litter box pan the front legs are inside the pan and the back legs are outside the pan.

When the device is in place the flat surface board is parallel to the litter box pan.

The front and back legs are made of plastic, recycled plastic, rubber, or metal materials.

The flat surface and hooks are made of plastic, recycled plastic, rubber, or metal materials.

While this embodiment is described as removable, it is also adjustable both vertically and horizontally to accommodate multiple sizes of litter boxes and different size waste bags. The hooks also can be adjustable to accommodate different size bags.

FIG. 1B illustrates the bag 5 attached to invention device on the wall of a litter box.

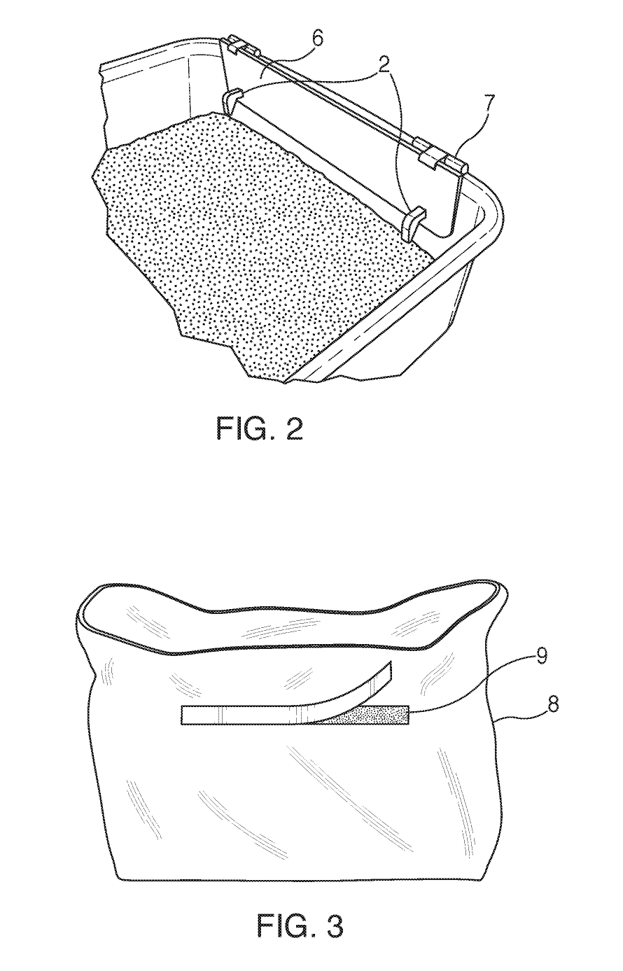

FIG. 2 illustrates a second embodiment of the invention which has a movable hinged 7 flap 6 with two hooks 2 on the inside surface of the litter box. In an alternate embodiment the flap can be weighted down to keep in place or a pair of magnets can be used to keep the flap stationary.

In another alternate embodiment a flat plastic rectangular panel with a wide hook(s) and a magnet inside is provided. A wall of the litter box has a magnet inside so the hooked rectangular panel could attach to it. The rectangular panel with the hook can be stuck and stored on the outside wall for storage and then placed on the inside wall when used for a cleaning. There could also be two plastic rectangular panels, one with magnets inside and a hook(s) outside and another with just a rectangular panel.

As illustrated in FIG. 3, the invention provides a litter bag 8 that has an adhesive strip 9 on the outside edge of the bag. This adhesive strip is similar to that found on an envelope so it can be sealed. One side of the bag can be longer to reach the inside of the litter box. Alternatively, sides of the bag can have slits going down the top so that the bag opens wider.

When ready to use the outer strip is removed to expose the adhesive portion which is then fixed to the interior wall of the litter box for cleaning. This bag can be used with the various invention embodiments or may be used alone. The strength of the adhesive is enough to hold the bag in place but not so strong so that it is easily removed and discarded after use.

When an individual goes to clean the litter box, he/she peels off the paper strip that was covering the adhesive 9, and then attaches the adhesive strip to the top inside edge of the litter box 1. The bag then is temporarily stuck to the inside of the litter box thus eliminating the gap between the litter box and bag. The individual can now scoop the waste litter out of the box without litter falling on the floor.

The litter bag can be scented or have designs thereon. The bags are available in different sizes according to the litter box being used.

Different types of adhesives can be used as long as they attach securely and peel off easily for disposal.

Multiple bags can be attached to the litter box for storage and easy use.

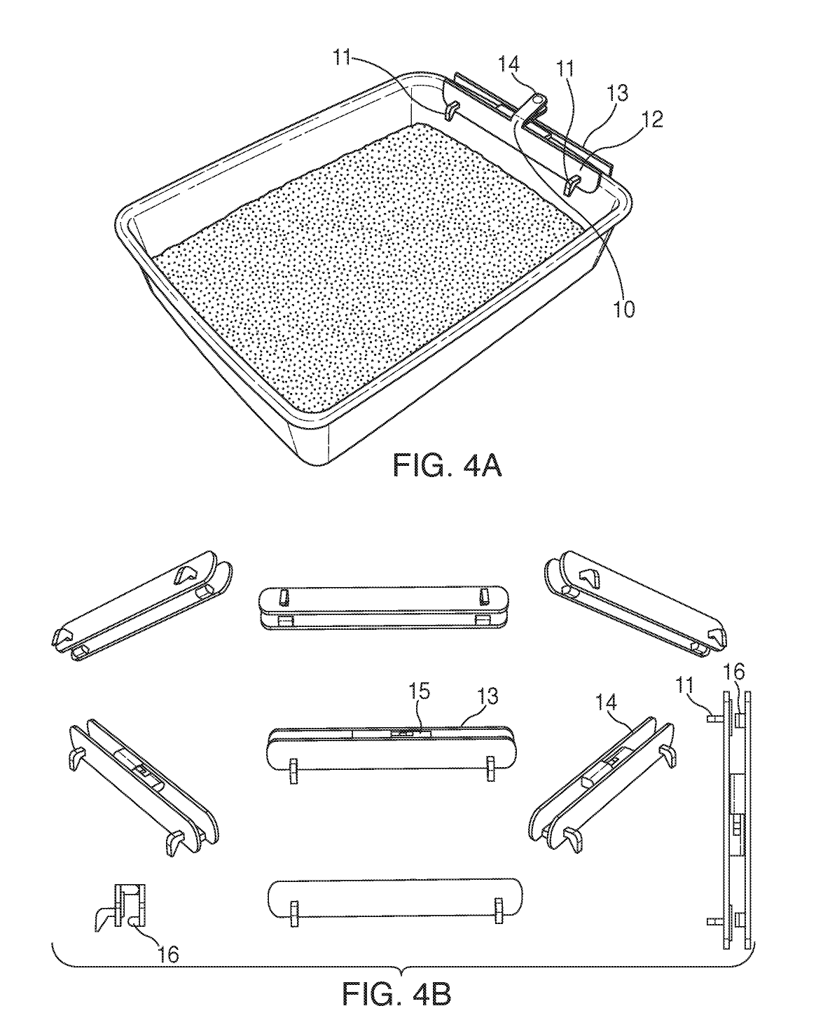

FIG. 4A illustrates a third embodiment where the device has two hooks 11 on a clip 10 which has a front plate 12 and a back plate 13 on the backside of the litter box. The front plate has two hooks 11 on the side inside the litter box. In this embodiment there is a top clip 14 holding said front and back plates together on place on the rim of the litter box. A waste bag is placed over the hooks 11 when the user is ready to clean the box. This prevents litter and waste from falling outside of the box.

FIG. 4B illustrates the third embodiment of the invention from multiple perspectives. In particular an alternate mechanism to open and lock clip on litter box rim 15 is provided. This mechanism slides and locks the clip in place on the rim. There are two horizontal protrusions 16 on the inside surface of the back plate 13 to secure clip in place on backside of litter box wall. In alternate embodiments the clip 10 can be one wide hook or two or more hooks on a clip.

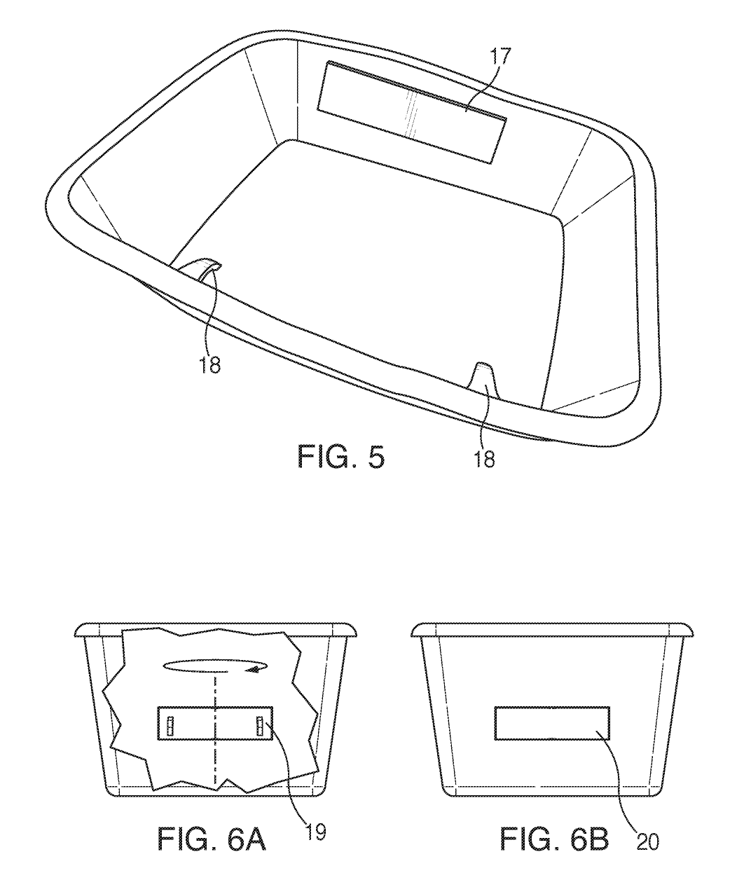

FIG. 5 shows two separate embodiments in one figure. This figure illustrates a fourth embodiment which is a stationary flap 17 on the wall of the litter box that protrudes from the side wall and can be used to attach a waste bag. The plastic flap 17 on the wall can optionally have slits to insert and secure a waste bag.

Alternatively, the plastic flap 17 can be placed higher on the litter box wall such that the top edge is an inch or two above the litter box. The waste bag would be secured over this flap and used to clean out the box.

The flap attached to the inside wall of the litter box maybe plastic, rubber or cardboard which the waste bag hooks onto. The flap can be connected by glue, double sided tape, hinges or can be part of the litter box mold.

It also illustrates a fifth embodiment shown on the opposite side where hook(s) 18 are attached to the top wall of the inside of the litter box and is used to attach a waste bag. Both flap and hooks can come in detachable versions and can have magnets (on both sides) that allow the hook and flap to stay on the litter box wall and easily removed after a cleaning.

The hooks protrude off the inside wall in a pointed and downward fashion. The number of hooks used in the invention vary from one to a plurality. In most preferred embodiments at least two hooks are used, although one wide hook can also be used. Preferably two hooks are stuck to the inside wall of a litter box with the curved pointed tip facing downward, so that a person can hook a trash bag onto the hook easily so the bag doesn't move or get pulled off the litter box while the litter box is cleaned.

The hooks are attached to the litter box wall in a number of different ways. They can be attached with an adhesive backing, they can be molded as part of the litter box mold or they can be attached with an adhesive loop and fastener material.

FIGS. 6A and 6B illustrate a sixth embodiment of the invention which is a movable tab with hooks on one side to attach a waste bag. When not in use the movable tab can be flipped over with the hooks now on the backside of the litter box and the inside surface of the litter box smooth.

In another similar embodiment, two movable squares, each with a hook, are incorporated into the side of a litter box. The hook side of the squares face outward from the litter box, and can then both squares can be pushed so that the hook moves to the inside of the litter box. The squares resemble the way the boxes on Wheel of Fortune used to move to reveal a letter. Once the hooks have been rotated to face the inside of the box, the litter bag can be attached for cleaning.

Alternatively, other related devices are part of the invention and include a flap with hooks, device with hooks and clips with hooks, all with at least one hook placed on the inside wall of the litter box pan where a waste bag can be fixed too to prevent a mess while cleaning. These embodiments are described more fully below in accordance with the respective figures.

Preferably the hooks have a curved pointed tip such that the tip is in a downward position. This is so a waste bag can be attached and secured to the hooks while the box is being cleaned. The tip of the hook while pointed is actually rounded so to secure the bag but not to puncture the bag when in place.

The pan and hooks are an integral structure that has been molded as one continuous material. The advantage of a unitary integral structure would prevent the hooks from breaking or falling off.

All embodiments described can be made with one wide hook.

The components of the invention are made of plastic, recycled plastic, rubber, or metal materials. Preferably the pan and hooks are made of plastic.

The invention eliminates the gap between the bag and the box where litter would fall though. A person can easily hold the bag open with one hand and scoop out the litter with the other.

Possible variations include different shaped hooks to optimize the ability of the waste bag to stay attached to the inside wall of the litter box. Other variations include different numbers of hooks hooks (one or more total) inside the litter box wall to accommodate different size trash bags. The hooks can be deeper to better grasp a bag and may need to be part of the mold used to create a litter box. The hooks are attached to the litter box with a form of double sided tape and that will not stay attached as well as hooks that are actually part of the litter box's manufactured mold. The same attachments means can be used if knobs and clips are used in place of hooks.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A removable litter box device to assist in no mess cleaning comprising:
a flat surface board;
a pair of front legs attached to said board which include attachment means for attaching a waste bag;
a pair of back legs attached to said board such that when said device is placed on a litter box pan said front legs are inside the pan and said back legs are outside the pan; and
a waste bag, which fits over the attachment means and enables to user to clean the litter pan without litter spilling over outside the pan.

2. A litter box device according to claim 1, wherein said attachment means is selected from the group consisting of hooks, clips, knobs and flaps.

3. A litter box device according to claim 2, comprising further at least two hooks with a rounded curved pointed tip attached on opposite ends of said flat surface such that the curved pointed tip points in a downward position

4. A litter box device according to claim 1, wherein said flat surface board is parallel to the litter box pan.

5. A litter box device according to claim 1, wherein said front and back legs are made of plastic, recycled plastic, rubber or metal materials.

6. A litter box device according to claim 1, wherein said flat surface and attachment means are made of plastic, recycled plastic, rubber, or metal materials.

7. A litter box comprising a four walled pan with one wall including attachment means to attach a waste bag to the litter box, said means are an integral part of the wall.

8. A litter box according to claim 5 wherein said attachment means are selected from the group consisting of hooks, clips, knobs and flaps.

9. A litter box according to claim 6, wherein said hooks have a curved rounded pointed tip such that the tip is in a downward position.

10. A litter box according to claim 5, wherein said pan and attachment means are made of plastic, recycled plastic, rubber or metal materials.

11. A litter bag with an adhesive strip 2 on the outside edge of the bag.

12. A removable litter box device to assist in no mess cleaning comprising:
a movable flat surface board;
a pair of attachment means for attaching a waste bag;
wherein the a waste bag, which fits over the attachment means and enables to user to clean the litter pan without litter spilling over outside the pan.

13. A litter box device according to claim 12, wherein said attachment means is selected from the group consisting of hooks, magnets, clips, knobs and flaps.

14. A litter box device according to claim 13, comprising further at least one hook with a rounded curved pointed tip.

15. A litter box device according to claim 13, comprising further at least two hooks with a rounded curved pointed tip attached on opposite ends of said flat surface such that the curved pointed tip points in a downward position

16. A litter box device according to claim 12, wherein said flat surface board is parallel to the litter box pan.

17. A litter box device according to claim 12, wherein said flat surface and attachment means are made of plastic, recycled plastic, rubber, or metal materials.

18. A removable litter box device comprising:
at least two hooks mounted on the front side of a flat surface; two attachment means on the backside of the flat surface; wherein said attachment means slide into place inside a litter box pan and a waste bag can be placed over said hooks.

19. A removable litter box device according to claim 18, wherein said attachment means are clips.

20. A litter box device comprising a movable tab with hooks on the inside surface of a litter box, wherein a waste bag is attached to said hooks.
